(19) United States
(12) Patent Application Publication
(10) Pub. No.: US 2022/0087217 A1
(43) Pub. Date: Mar. 24, 2022

(54) PORTABLE PET TRAVEL CUP WITH PREFILLED WATER AND SEALABLE LID

(71) Applicant: Brandon D. Pierce, CORONA, NY (US)

(72) Inventor: Brandon D. Pierce, CORONA, NY (US)

(21) Appl. No.: 17/027,531

(22) Filed: Sep. 21, 2020

(51) Int. Cl. A01K 7/00; B65D 55/02; B65D 53/02; B65D 43/02; B65D 85/72

(52) U.S. Cl. CPC A01K 7/005; B65D 55/022; B65D 53/02; B65D 43/0283; B65D 2543/00092; B65D 2543/00537; B65D 2543/00972; B65D 2543/00527; B65D 85/72

(57) ABSTRACT

Disclosed are various embodiments of a portable pet hydration device (103) with a tamper-evident screw-on lid (101) that is watertight for maintaining and transporting prefilled water meant for hydrating animals; particularly, domesticated [pet] animals. After initially opening the device (103) and breaking its tamper-evident seal (102), the pet owner can reseal the device for future use by utilizing the screw-on lid (101). The cup's lid (101) screws securing onto outer continuous spiraling threads (201) on the cup's opening in order to create a watertight seal. The device's sealable nature allows the pet owner to store the device (103) in any position during travel without concern of leakage or to leave the device (103) open on the floor for indoor use. Once the contents have been consumed, the device can be disposed; thus, alleviating the need to constantly clean, refill, and maintain the device for future use.

### CROSS-REFERENCE TO RELATED APPLICATIONS

This application claims the benefit of provisional patent application Ser. No. 63/051,820, filed 2020 Jul. 14 by the present inventor, which is incorporated by reference in its entirety.

### FEDERALLY SPONSORED RESEARCH

None.

### SEQUENCE LISTING

None.

### BACKGROUND—FIELD

This application generally relates to pet watering equipment, particularly, a sealable container with prefilled water used to hydrate pets.

### BACKGROUND—PRIOR ART

The following is a tabulation of prior art that presently appears relevant:

### U.S. Patents

| Pat. No. | Kind Code | Issue Date | Patentee |
|---|---|---|---|
| D813468 | S | Mar. 20, 2018 | Cronkhite |
| 7878148 | B2 | Feb. 1, 2011 | Swenson |
| 7287487 | B2 | Oct. 30, 2007 | Hurwitz |
| 5105768 | A | Apr. 21, 1992 | Johnson |
| 4436056 | A | Mar. 13, 1984 | MacLeod |

### U.S. Patent Application Publications

| Publication No. | Kind Code | Publ. Date | App or Patentee |
|---|---|---|---|
| 20180103610 | A1 | Apr. 19, 2018 | Nero |
| 20130291802 | A1 | Nov. 7, 2013 | Carpentieri |

Pets are constantly on the move with their owners: dining out at restaurants, exercising outdoors, and even traveling on long commercial flights. In essence, pets are just as active as their human counterparts. With constant movement comes a need to remain hydrated, and just as a pet's owner must hydrate, so must the pet.

Historically, pets have depended on their owners to provide water during travel; however, doing so was extremely burdensome. The common scenario was an owner had to carry a bottle of water and a receptacle wide enough for the pet to consumer the water. That burdensome task stills exists today. In some scenarios, pet owners without a water bottle have to rely on finding a nearby water source to hydrate their pets, such as, a public restroom sink or park water fountain. Even in those scenarios where a water source is found, the second task is to find a receptacle from which the pet can drink the water. Often, that receptacle is a makeshift container or used cup, like an empty fast food drink cup.

In scenarios where the pet owner has to find a receptacle to hold the water, it is usually an object that cannot transport the water once the pet has finished drinking. In those instances, the owner has to either carry the wet receptacle, leaking with residual water, or dispose of the receptacle and hope to find another once the pet is thirsty again. Additionally, most impromptu receptacles do not possess openings wide enough for the pet to access the water with ease.

In the worst of scenarios, an owner does not have water or a receptacle for the pet to drink. In those situations, the pet is obligated to drink from stagnant water, such as water puddles, in order to remain hydrated. Such a scenario presents significant health risks for the pet.

Previous inventions have attempted to solve this hydration dilemma, but not withstanding multiple disadvantages. U.S. Pat. No. 7,878,148 (2011) to Swenson et al. discloses a high-maintenance bowl device that requires the owner to find a water source to fill the bowl, or fill the bowl before traveling. After use, the device's inside and outside surfaces must be cleaned, otherwise, they are susceptible to developing water-borne mold and harboring unsanitary bacteria which could harm the pet if ingested.

Another attempt to cure the hydration dilemma was made by NERO in US20180103610. This device is a plastic container filled with water, but is not watertight for traveling. Its sealing function relies on a thin covering that, once removed, reattaches to the bowl using a zipper seal; in similar fashion as a Ziploc bag. Thereby, rendering the device easily susceptible to ruptures and leakage when used during extremely rugged travel, such as hiking, or stored within tight, moving storage; such as, suitcases or sport bags.

U.S. Pat. No. 813,468 (2018) to Cronkhite was an attempt to provide water to traveling pets, but in the form of a cumbersome, engorged container that is not suitable for all traveling. This container is limited in how it may be positioned. If positioned improperly, the water will leak from therein, thus, rendering the device obsolete for the active traveler. Additionally, the container's size does not allow for compact traveling; such as, onboard planes and hiking trips. Hurwitz provides a water bottle, cup and dish assembly in U.S. Pat. No. 7,287,487. However, the device's assembly is arduous to the busy pet owner as it has multiple moving parts that must be maintained while traveling. Additionally, the device is too bulky for travelers needing to pack light. Lastly, the assembly inconveniences the pet owner since a water bottle must be acquired and carried to attach to the device.

Additional inventions designed to provide water to the traveling pet include: U.S. Pat. No. 6,101,974 to Frohlich (2000); U.S. Pat. No. 7,040,249 to Mushen (2005); U.S. Pat. No. 5,209,184 to Sharkan (1993); U.S. Pat. No. 7,578,261 to Fick (2005); US20080115732 to Stenberg (2006); and US20060236948 to Wechsler (2006). Nonetheless, the last-mentioned prior art references fail to solve the dilemma of having to constantly find drinking water along with a receptacle to hold and transport the water for the traveling pet.

The functionality and manufacturing of prior art fail to satisfy market demand for pet hydration needs. The present embodiments are geared toward alleviating one or more of the above-referenced limitations. In sum, insofar as I am aware, no traveling pet embodiment formally developed provides fresh, prefilled water in a tamper proof screw lid container for pets.

### SUMMARY OF THE INVENTION

In accordance with one embodiment, a pet hydration device comprising a circular dish-like plastic container holding prefilled drinking water and sealed with a tamper-evident screw-on lid. The device contains a tamper-evident seal, which assures the owner that the pet's water is fresh and unaltered from the time of manufacturing. The seal is broken once the user unscrews the device's lid upon its initial opening, revealing fresh drinking water. If the pet does not consume all the liquid contents in one sitting, the container may be resealed and unsealed continuously utilizing the screw-on lid until the water has been completely consumed.

### ADVANTAGES

Accordingly, several advantages of one or more aspects exist, in that the device:
A. Simplifies carrying fresh drinking water for traveling pets by utilizing a 2-in-1 feature: fresh drinking water and a sealable watertight container conveniently packaged into one device. No longer must the pet owner travel with a water bottle and a separate pet-drinkable container.
B. Comprises a tamper-evident lid to ensure the integrity of its liquid contents has not been compromised before opening.
C. Contains a resealable screw-on lid to retain its liquid contents until full consumption.
D. Is disposable and recyclable once all its contents have been consumed.
E. Is maintenance-free, as it does not require excessive cleaning or treatment before or after each use.
F. Can be used by individuals of various ages and sizes without requiring special training on how to be used.
G. Contains fresh, prefilled drinking water from a known water source so that the pet's owner is assured the water does not contain any harmful contaminants.
H. Is lightweight and gradually decreases in weight while traveling as the pet drinks more water from the container.
I. Can be sealed with a screw-on lid equipped with continuous threads that intertwine with the device, thereby creating a watertight seal that prevents leakage during transport.
J. Is compact in size to be used and easily stowed in small spaces while traveling.
K. Can be used in outdoor and indoor settings.
L. Is more sanitary than water from public restrooms, park fountains, and municipal potable water tanks that store water overtime for household use.
M. Can be made available to consumers in multipacks consisting of several containers to ensure the pet does not run out of water during travel.
N. Ranges in size to accommodate the smallest to the largest of pet variety and breed.
O. Is a quick and easy way to hydrate a pet without excessive operating parts and compartments.
P. Has a discrete nature, in that it can be used in crowded spaces, such as, airplanes and offices, simply by being held in the pet owner's hand while the pet drinks.

### DRAWINGS—FIGURES

FIG. 1—A lateral view.

FIG. 2—An exploded view.

FIG. 3—A right-side top view.

FIG. 4—A bottom perspective view of the screw-on lid.

FIG. 5—A top view of a detached tamper-evident seal.

### DRAWINGS—REFERENCE NUMERALS

Ref. 101—Screw-on lid

Ref. 102—Tamper-evident seal

Ref. 103—Portable pet travel cup

Ref. 104—Cup base

Ref. 201—Outer continuous threads [opening mouth]

Ref. 401—Inner continuous threads [screw-on lid]

Ref. 501—Gripping teeth

### BRIEF DESCRIPTION OF THE DRAWINGS

As is in common practice, the multiple features within the drawings described below are not necessarily drawn to scale. The features' dimensions and various elements may be reduced or expanded to clearly illustrate each embodiment.

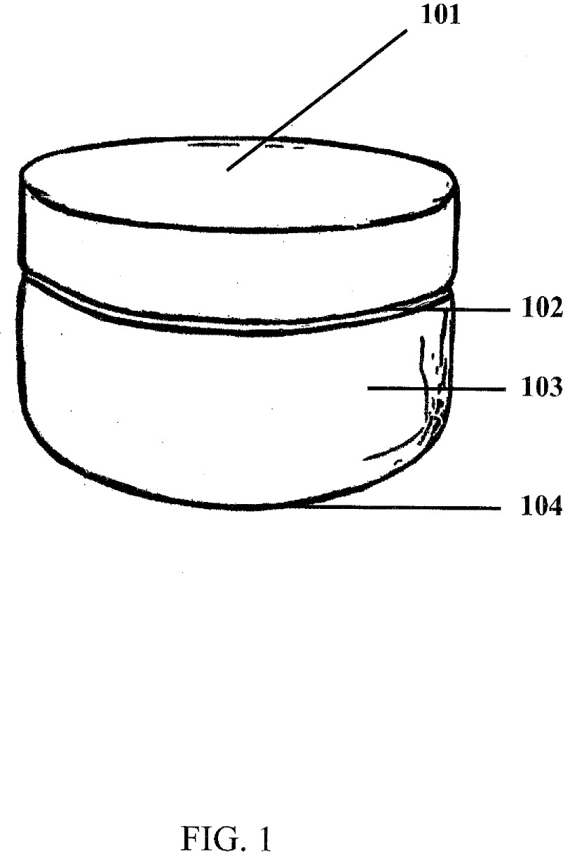

FIG. 1 illustrates a side perspective view of a portable animal hydration device constructed in accordance with an embodiment of the present invention.

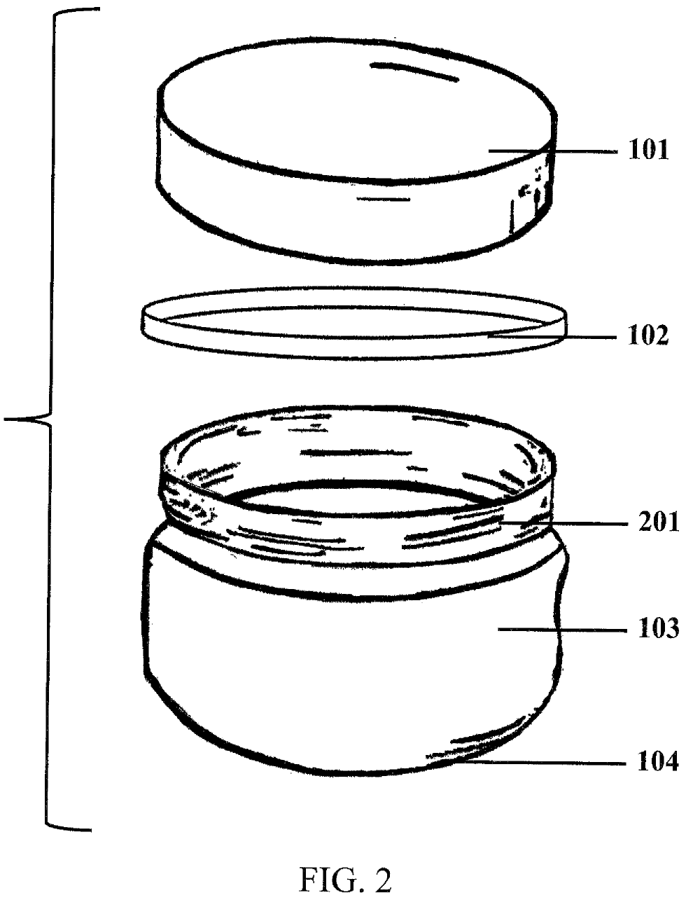

FIG. 2 depicts an exploded perspective view of a portable animal hydration device in conformity with one embodiment.

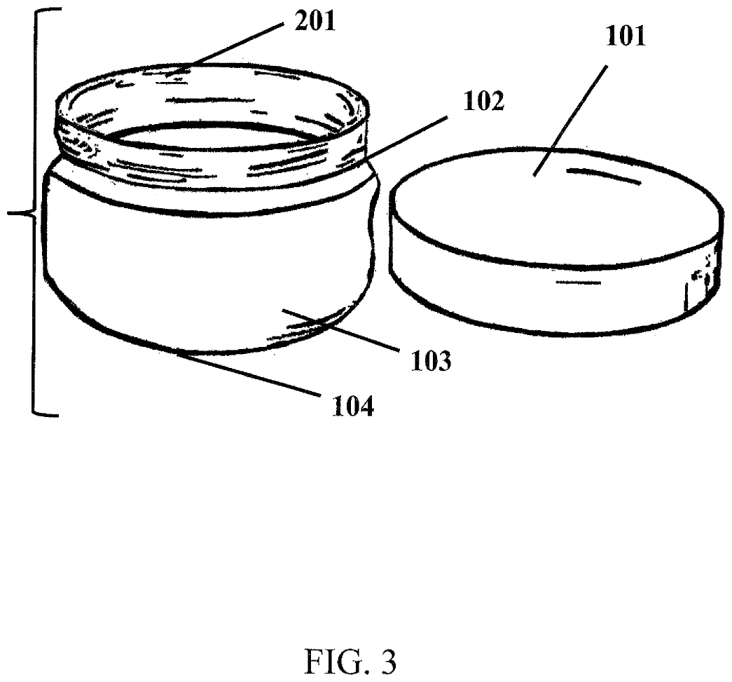

FIG. 3 shows a view of the side profile of a portable animal hydration device conforming to one embodiment of the present invention, illustrating how the opened device may be placed on a level surface for pet consumption.

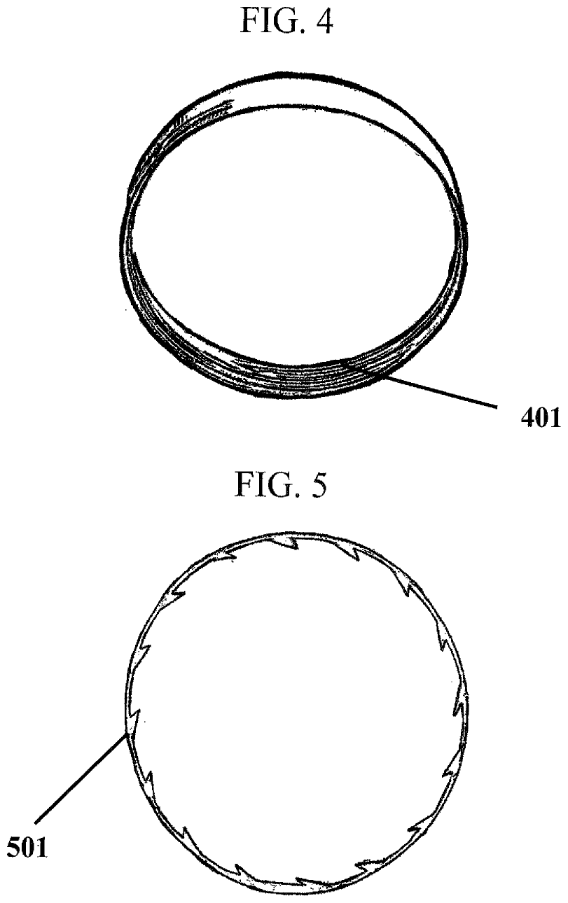

FIG. 4 illustrates a bottom view perspective of a screw-on lid and exposes its continuous spiraling threads.

FIG. 5 shows the inwardly pointing teeth within a tamper-evident seal in accordance with one embodiment, used to seal the hydration device until broken.

### DETAILED DESCRIPTION OF SPECIFIC EMBODIMENTS

In operation, the pet owner uses the cup 103 in the same manner as a pet water dish, but with the added features of portability and being able to open and close the cup as one would a water bottle. FIGS. 1 and 2 show a perspective view of one embodiment, which comprises a pet cup 103 prefilled with water and covered with a screw-on lid 101 that is sealed with a tamper-evident seal 102. The user can hold the cup 103 in hand or place the base 104 on a flat-level surface before firmly unscrewing the lid 101 to break the teeth 501 within the tamper-evident seal 102.

FIG. 5 shows one embodiment of the tamper-evident seal, which consists of teeth that grip the lid 101 to the cup 103. However, this and other methods for forming a tamper-evident seal are adequate. The preferred embodiment's tamper-evident design encompasses a seal consisting of a circular band 102 with gripping teeth 501 that only breaks when the owner twists the lid 101 off the cup 103. Alternatively, the embodiment can be designed with a seal comprising a perforated plastic shrink band that wraps around the lid 101 and the cup 103. Furthermore, another embodiment is designed with a tamper-evident seal comprising an adhesive security tape that simultaneously attaches to the lid 101 and cup 103 until broken upon removing the lid 101. Once the seal 102 and lid 101 have been removed, the pet will have access to fresh drinking water.

FIG. 4 shows the plurality of continuous threads within the screw-on lid's inner lining. When traveling, if the pet has finished drinking, but liquid remains in the cup 103, the lid 101 contains inner continuous threads 401 that can be screwed onto the threaded opening 201 to form a watertight seal and securely retain leftover water. Once the lid 101 is secured, the cup 103 can be stowed so the owner may continue traveling. Should the pet need another serving, the cup 103 can be unsealed and resealed until the water is depleted. At which point in time, the cup 103 may be disposed of for recycling purposes.

The cup's utilization is not limited to traveling outside of the pet's home. FIG. 3 illustrates how the pet owner may use the cup 103 in everyday indoor settings [e.g., the home, office, or automobile] by simply unscrewing the lid 101 and placing the cup on a level surface for pet consumption until all water has been consumed.

### CONCLUSION, RAMIFICATIONS, AND SCOPE

Accordingly, the reader will see the various embodiments can be used to provide fresh drinking water to pets in a manner that is safe, quick, and convenient. In addition, the cup can be sealed watertight and stowed in the pet owners traveling storage for impromptu use. In essence, the embodiments alleviate the pet owner of the unfortunate scenario of not having access to immediate, clean drinking water for his or her pet while traveling. This dilemma has yet to be met by prior art.

The various embodiments do not require training or strenuous assembly and maintenance as similar art in the marketplace. Rather, they provide a more reliable, lightweight, yet economical, method of hydrating the traveling pet. Furthermore, the operation and conceptual use are similar to those of a plastic water bottle used for human consumption and can be used by persons of almost any age. The embodiments are easy to open, fit in one human hand, and are disposable.

The majority of prior art requires the owner to add water to the device, after which, the device must be cleaned and the water reapplied. Conversely, the various embodiments presented complete the pet owner's job insofar as they provide the drinking water and the watertight device used to transport and serve the drinking water. Once the water is consumed, the pet owner can dispose of the device and simply grab another prefilled device for the next serving or trip.

Even pet owners who do not travel with their pet can take advantage of the various embodiments as they provide a clean source of water for in-home use, unlike most current art in the marketplace. Not every household contains tap water that is ideal for pet consumption. Nonetheless, many owners have no alternative but to provide their pets with tap water with high mineral contents and infested with microbiological contaminants. This device can be stored in bulk within the pet owner's home and placed on a level surface for continuous, casual consumption at the pet's leisure.

The embodiments are healthy alternatives for traveling pets that rely on puddles, standing wastewater, and public water (e.g., public restrooms or pet park fountains) to satisfy their thirst. This likely scenario assumes the pet is willing to spontaneously drink unfamiliar water, as many animals are sensitive to water outside the home, particularly the odorous water found in public. The various embodiments provide fresh water from a known source. Further, as the pet becomes accustomed to drinking from the device overtime, it will begin to trust the water by recognizing its taste and smell.

The multiple specificities mentioned in the description above should not be construed as limiting the scope of the device. For example, the cup can come in various sizes filled with corresponding amounts of water to accommodate the size of the pet. Also, the consumer can purchase the device in multipacks (e.g., 4-cups, 8-cups, etc.) based on pet's water consumption level, etc.

As such, the appended claims and their legal equivalents should be used to determine the embodiments' scope, as oppose to the examples given above.

I claim:

1. An animal hydration device, comprising:
(a) a container of a predetermined size and shape prefilled with a consumable liquid, and
(b) a screw-on lid that fastens to a rimmed mouth opening of said container, and
(c) a tamper-evident seal being attached simultaneously to said container and said screw-on lid.

2. The animal hydration device of claim 1 wherein said animal is a domesticated “pet” animal.

3. The animal hydration device of claim 1 wherein said consumable liquid is water.

4. The animal hydration device of claim 1 wherein said device is disc-shaped and composed of recyclable material.

5. The animal hydration device of claim 1 wherein said rimmed mouth opening comprises:
(a) a circular surface protruding in an upward fashion from the opening of said container, and
(b) continuous threads spiraling horizontally around the protruding surface, and
(c) a sufficient diameter as to allow said animal access to said water by inserting its tongue into said rimmed mouth opening.

6. The animal hydration device of claim 1 wherein said screw-on lid comprises:
(a) a disc-shaped sheet of rigid material of sufficient size to completely cover said rimmed mouth opening, and
(b) a diameter of sufficient size to accommodate removal by one pair of human hands, and
(c) internal continuous threads that intertwine and lock with the threads on said rimmed mouth opening.

7. The animal hydration device of claim 1 wherein said tamper-evident seal comprises:
(a) a circular shaped band with gripping teeth attached simultaneously onto said screw-on lid and said rimmed mouth opening,
(b) a perforated shrink wrap plastic enclosed simultaneously around said screw-on lid and said rimmed mouth opening, and
(c) an adhesive tape attached simultaneously onto said screw-on lid and said rimmed mouth opening.

8. A method of sealing an animal hydration device consistent with claim 1, comprising:
(a) twisting said screw-on lid onto said rimmed mouth opening such that the threads interlock in a continuous spiraling downward fashion until said twisting halts and arrives to a stopping point, and
(b) whereby, said stopping point forms a leakproof seal between said rimmed mouth opening and said screw-on lid to keep said water therein.
